(19) United States
(12) Patent Application Publication
(10) Pub. No.: US 2018/0117886 A1
(43) Pub. Date: May 3, 2018

(54) PEST REPELLENT AND/OR RECYCLABLE MULTILAYER SHEET MATERIAL AND PACKAGING MADE THEREFROM

(71) Applicant: THE WILPAK GROUP PTY LTD, Melbourne, Victoria (AU)

(72) Inventor: Adam Wilson, Balwyn, Victoria (AU)

(21) Appl. No.: 15/569,911

(22) PCT Filed: Apr. 29, 2015
(86) PCT No.: PCT/AU2015/050206

§ 371 Date: Oct. 27, 2017

(30) Foreign Application Priority Data
Apr. 30, 2014 (AU) 2014901558

(51) Int. Cl. B32B 27/08; B32B 3/12; B32B 27/32; B65D 81/02; B65D 81/38

(52) U.S. Cl. CPC B32B 27/08; B32B 3/12; B32B 27/32; B65D 65/44; B65D 81/38; B32B 2553/026; B32B 2307/744; B32B 2307/584; B32B 2307/558; B32B 2307/764; B32B 2307/304

(57) ABSTRACT

Multilayer sheet material, comprising: a first layer attached to a second layer, wherein: the first layer is an insulative layer or a protective layer; the second layer is a cushioning layer; and wherein one or both of the first and second layers is: pest repellent; recyclable; or both pest repellent and recyclable.

### FIELD

The present invention relates to pest repellent and/or recyclable multilayer sheet material and packaging made therefrom.

### BACKGROUND

Metallic, plastic and foam sheet materials are used to cushion, protect and insulate products and structures. For example, plastic shrink wraps, foam wraps and air cellular cushioning wraps (or BubbleWrap®) are used to cushion and protect products during storage and transportation. Metallic foil liners are used to provide thermal insulation in containers, and in building roofs and walls.

Conventional metallic, plastic and foam sheet materials have various disadvantages. For example, they generally provide one or two of cushioning, protection and insulation, but not all three. In addition, metallic, plastic and foam sheet materials are susceptible to attack and penetration by pests, such as animal pests and insect pests. Further, composite packaging sheet material, such as metal foil-faced bubble wrap, is generally not recyclable “as is” because the metal foil must first be separated from the bubble wrap.

In this context, it is desirable to provide improved sheet material and packaging made therefrom.

### SUMMARY

According to the present invention, there is provided multilayer sheet material, comprising:

a first layer attached to a second layer, wherein:
the first layer is an insulative layer or a protective layer;
the second layer is a cushioning layer; and

wherein one or both of the first and second layers is:
pest repellent;
recyclable; or
both pest repellent and recyclable.

The multilayer sheet material may further comprise a third layer, wherein the second layer is attached between the first and third layers.

The third layer may be an insulative layer or a protective layer.

The first layer may be an insulative layer, and the third layer may be a protective layer.

Alternatively, each of the first and third layers may be an insulative layer.

Further alternatively, each of the first and third layers may be a protective layer.

The insulative layer may have a reflective appearance, a metallic appearance, or a combination thereof.

The insulative layer may comprise a metallic film, a metallic coating, a plastic material printed with a metallic ink, a plastic material containing metallic particles, a plastic material containing metallic powder, or a combination thereof. The metallic ink may comprise a water-based metallic ink or a solvent-based metallic ink.

The protective layer may have an anti-scuff surface finish, an anti-slip surface finish, or a combination thereof.

The protective layer may be made of a plastic material.

The cushioning layer may comprise a foam material, an air cellular cushioning material, or a combination thereof.

The cushioning layer may be made of a plastic material.

One, two or three of the first, second and third layers may be made of a plastic material.

The plastic material may comprise a recyclable plastic material.

The recyclable plastic material may have a Recycling Code of between 2 to 6, for example, 4.

The recyclable plastic material may be selected from polyethylene (PE), low density polyethylene (LDPE), and high density polyethylene (HDPE).

The multilayer sheet material may comprise first and second layers each made of the recyclable plastic material, wherein the multilayer sheet material is recyclable in integral form without separating the first and second layers from one another. For example, the first layer may comprise PE, and the second layer may comprise LDPE.

The multilayer sheet material may comprise first, second and third layers each made of the recyclable plastic material, wherein the multilayer sheet material is recyclable in integral form without separating one or two of the first, second and third layers from one another. For example, the first layer may comprise PE, the second layer may comprise LDPE, and the third layer may comprise HDPE.

The plastic material of the one, two or three of the first, second and third layers may incorporate a pest repellent.

The pest repellent may comprise an animal repellent, an insect repellent, or a combination thereof. For example, the animal repellent may comprise a rodent repellent.

The pest repellent may be non-toxic to humans, and compatible with food products. The pest repellent may comprise a naturally occurring compound, a synthetic compound, or a combination thereof. For example, the pest repellent may comprise cayenne pepper.

The present invention also provides packaging made from the multilayer sheet material described above. The packaging may be selected from an envelope, a sheet, a wrap, a cover, a bag, a liner, a barrier sheet, a container, a pallet cover, a pallet base, a wall or roof liner, an insulation sheet, a thermal blanket, or a combination thereof.

The present invention further provides a method, comprising:

forming multilayer sheet material comprising a first layer attached to a second layer, wherein:
the first layer is an insulative layer or a protective layer;
the second layer is a cushioning layer; and

wherein one or both of the first and second layers is:
pest repellent;
recyclable; or
both pest repellent and recyclable.

### BRIEF DESCRIPTION OF DRAWINGS

Embodiments of the invention will now be described by way of example only with reference to the accompanying drawings, in which:

FIG. 1 is a section view of multilayer sheet material according to an embodiment of the invention; and

FIG. 2 is a perspective view of the multilayer sheet material of FIG. 1.

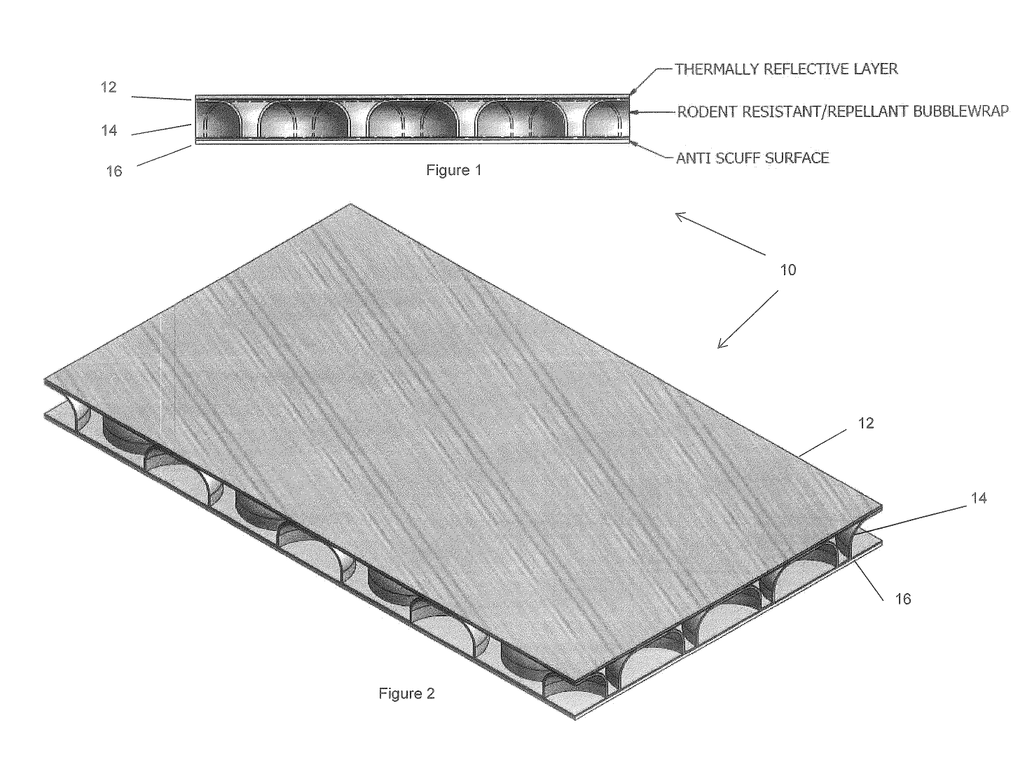

### DETAILED DESCRIPTION

Referring to the drawings, multilayer sheet material 10 according to one embodiment of the invention may generally comprise a first layer 12 attached to a second layer 14. The first layer 12 may be an insulative layer or a protective layer, and the second layer 14 may be a cushioning layer. One or both of the first and second layers 12, 14 may be pest repellent, recyclable, or both pest repellent and recyclable.

In another embodiment, the multilayer sheet material 10 may further comprise a third layer 16. The second layer 14 may be attached between the first and third layers 12, 16 in sandwich-like fashion by laminating, coating, bonding, gluing, co-moulding, over-moulding, and combinations thereof. The third layer 16 may be an insulative layer or a protective layer. In one embodiment, the first layer 12 may be an insulative layer, and the third layer 16 may be a protective layer. In an alternative embodiment, each of the first and third layers 12, 16 may be an insulative layer. In a further alternative embodiment, each of the first and third layers 12, 16 may be a protective layer. The first layer 12 may be oriented to be an outer layer of the multilayer sheet material 10, and the third layer 16 may be an opposite inner layer, or vice versa.

The insulative layer may have a reflective appearance, a metallic appearance, or a combination thereof. The insulative layer may provide thermal insulation, and may be aesthetically pleasing. The insulative layer may comprise a metallic film, a metallic coating, a plastic material printed with a metallic ink, a plastic material containing metallic particles, a plastic material containing metallic powder, or a combination thereof. The metallic ink may comprise a water-based metallic ink or a solvent-based metallic ink.

The protective layer may have an anti-scuff surface finish, an anti-slip surface finish, or a combination thereof. The protective layer may provide non-slip, anti-scuff and anti-puncture protection for the second, cushioning layer 14. The protective layer may be made of a plastic material.

The second, cushioning layer 14 may comprise a foam material, an air cellular cushioning material, or a combination thereof. The second, cushioning layer 14 may provide protection, cushioning, thermal insulation, and impact absorption. The second, cushioning layer 14 may be made of a plastic material.

In certain embodiments, one, two or three of the first, second and third layers 12, 14, 16 of the multilayer sheet material 10 may be made of a plastic material by sheet extrusion, die extrusion, co-extrusion, lamination, and combinations thereof. Other equivalent or alternative construction techniques may also be used. The plastic material may comprise a recyclable plastic material. The recyclable plastic material may have a Recycling Code (or a Plastics Identification Code) of between 2 to 6, for example, 4. The Plastics Identification Code may, for example, be based on industry standardised coding of the Society of the Plastics Industry (SPI) in the United States, or the Plastics and Chemicals Industries Association (PCIA) in Australia. The recyclable plastic material may be selected from polyethylene (PE), low density polyethylene (LDPE), and high density polyethylene (HDPE). Optionally, the recyclable plastic material may be biodegradable and compostable. Other equivalent or alternative recyclable plastic materials may also be used.

In one embodiment, the multilayer sheet material 10 may comprise first and second layers 12, 14 each made of the recyclable plastic material, so that the multilayer sheet material 10 is recyclable “as is” in integral form without separating the first and second layers 12, 14 from one another. For example, the first layer 12 may comprise PE, and the second layer 14 may comprise LDPE.

In another embodiment, the multilayer sheet material 10 may comprise first, second and third layers 12, 14, 16 each made of the recyclable plastic material, so that the multilayer sheet material 10 is recyclable “as is” in integral form without separating one or two of the first, second and third layers 12, 14, 16 from one another. For example, the first layer may comprise PE, the second layer may comprise LDPE, and the third layer may comprise HDPE.

In certain embodiments, the plastic material comprising the one, two or three of the first, second and third layers 12, 14, 16 of the multilayer sheet material 10 may incorporate a pest repellent. In various embodiments, the plastic material of one, two or three of the first, second and third layers 12, 14, 16 may be a recyclable plastic material as described above. The pest repellent may be added to a plastic mix or resin to form the plastic material of one, two or three of the first, second and third layers 12, 14, 16. The pest repellent may comprise an animal repellent, an insect repellent, or a combination thereof. For example, the animal repellent may comprise a rodent repellent. The pest repellent may be non-toxic to humans, and compatible with food products, such as milk powder. For example, the pest repellent may not contaminate or leach into food products to adversely affect their appearance, flavour or taste, either at all or to any significant or noticeable extent. The pest repellent may comprise a naturally occurring compound, a synthetic compound, or a combination thereof. For example, the pest repellent may comprise cayenne pepper. Other equivalent or alternative pest repellents may also be used.

It will be appreciated from the above description that the multilayer sheet material 10 of different embodiments may comprise one, two or three of the first, second and third layers 12, 14, 16 in different combinations to provide corresponding different combinations of thermal insulation, cushioning and protection. Further, one, two or three of the first, second and third layers 12, 14, 16 may be pest repellent, recyclable, or both pest repellent and recyclable.

Packaging may be formed or made from the multilayer sheet material 10 described above. The packaging may be selected from an envelope, a sheet, a wrap, a cover, a bag, a liner, a barrier sheet, a container, a pallet cover, a pallet base, a wall or roof liner, an insulation sheet, a thermal blanket, or a combination thereof.

Embodiments of the present invention provide multilayer sheet material that is useful for forming a wide range of packaging which is pest repellent, recyclable, or both pest repellent and recyclable.

For the purpose of this specification, the word “comprising” means “including but not limited to”, and the word “comprises” has a corresponding meaning.

The above embodiments have been described by way of example only and modifications are possible within the scope of the claims that follow.

1-31. (canceled)

32. Multilayer sheet material, comprising:
a first layer, comprising an insulative layer;
a second layer attached to the first layer, wherein the second layer comprises a cushioning layer; and
a third layer attached to the second layer, wherein the third layer comprises a protective layer;
wherein each of the first, second and third layers comprise a recyclable plastic material.

33. The multilayer sheet material of claim 1, wherein the recyclable plastic material comprises low density polyethylene (LDPE).

34. The multilayer sheet material of claim 1, wherein the insulative layer has a reflective appearance or a metallic appearance.

35. The multilayer sheet material of claim 1, wherein the insulative layer comprises a metallic film, a metallic coating, a recyclable plastic material printed with a water-based metallic ink or a solvent-based metallic ink, a recyclable plastic material containing metallic particles, a recyclable plastic material containing metallic powder, or combinations thereof.

36. The multilayer sheet material of claim 1, wherein the cushioning layer comprises an air cellular cushioning material.
